(19) United States
(12) Patent Application Publication
(10) Pub. No.: US 2003/0074343 A1
(43) Pub. Date: Apr. 17, 2003

(54) Personal information management method, personal information management apparatus, and recording medium

(75) Inventor: Yoshikazu Onuki, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/103,727

(22) Filed: Mar. 25, 2002

(30) Foreign Application Priority Data
Oct. 17, 2001 (JP) 2001-320012

(51) Int. Cl. G06F 7/00

(52) U.S. Cl. 707/1

(57) ABSTRACT

A method of managing personal information includes the steps of (a) receiving a confirmation from an individual as to whether personal information of the individual is to be stored in a storage part corresponding to the individual at a request of a service provider that the personal information be stored, (b) determining, based on the confirmation from the individual, whether the storage of the personal information in the storage part is authorized; and (c) storing the personal information of the individual in the storage part if the step (b) determines that the storage of the personal information is authorized.

### BACKGROUND OF THE INVENTION

1. Field of the Invention

The present invention generally relates to personal information management methods, personal information management apparatuses, and recording media, and more particularly to a personal information management method and apparatus for managing personal information such as a bank account number, a medical certificate issued by a hospital, and shopping points that shops issue for purchase of products, and a recording medium storing a program for executing such a method.

2. Description of the Related Art

Conventionally, personal information such as a bank account number, diagnostic information of a hospital, and shopping points issued for purchase of merchandise at shops has been managed by the owner of the personal information in the form of a paper “savings passbook”, a paper “medical certificate”, and a “point card”, respectively.

For instance, in the case of claiming for insurance payment by using personal information, a person who claims for the payment presents an insurance company with information such as a bank account number to which the payment is to be made and a medical certificate in the form of paper. This causes the problem that the payment claimer has to write the bank account number on a given form and, in some cases, has to go to the hospital to receive the medical certificate after medical treatment.

Further, in the case of shopping at a shop that issues a shopping point card, a person who has left the point card behind can neither earn nor spend points for any purchase of product.

### SUMMARY OF THE INVENTION

Accordingly, it is a general object of the present invention to provide a personal information management method by which the above-described disadvantages are eliminated.

A more specific object of the present invention is to provide a personal information management method that saves a person time and trouble in receiving a service for which the person is required to provide the personal information thereof.

Another more specific object of the present invention is to provide a personal information management apparatus suitable for performing such a method and a recording medium storing a program for performing such a method.

The above objects of the present invention are achieved by a method of managing personal information including the steps of (a) receiving a confirmation from an individual as to whether personal information of the individual is to be stored in a storage part corresponding to the individual at a request of a service provider that the personal information be stored, (b) determining, based on the confirmation from the individual, whether the storage of the personal information in the storage part is authorized, and (c) storing the personal information of the individual in the storage part if the step (b) determines that the storage of the personal information is authorized.

According to the above-described method, the individual can have her/his personal information stored in the storage part accessible by others. This saves the individual time and trouble in obtaining her/his information when necessary.

Additionally, the above-described method may further include the steps of (d) receiving a reference identifier corresponding to the personal information stored in the storage part from the individual or the service provider, and (e) extracting the personal information from the storage part based on the reference identifier.

Thereby, the individual is saved time and trouble in presenting her/his personal information when necessary.

Additionally, in the above-described method, the individual may transmit the confirmation from a first terminal and the service provider may transmit the request from a second terminal, the first and second terminals being connected electrically via a network.

Thereby, the individual is allowed to obtain her/his personal information and have the information referred to via the network. Therefore, the individual is saved time and trouble in receiving a service for which the individual is required to obtain and presents her/his personal information.

The above objects of the present invention are also achieved by an apparatus for managing personal information including: a storage part storing personal information of an individual corresponding to the storage part, the personal information corresponding to a request of a service provider; a first part receiving from the individual a confirmation as to whether the personal information is to be stored; a second part determining, based on the confirmation, whether the storage of the personal information in the storage part is authorized; and a third part storing the personal information in the storage part if the second part determines that the storage of the personal information is authorized.

The above-described apparatus is suitable for the above-described method.

The above objects of the present invention are further achieved by a computer-readable recording medium storing a program of instructions executable by a computer to perform a method of managing personal information, the method including the steps of (a) receiving a confirmation from an individual as to whether personal information of the individual is to be stored in a storage part corresponding to the individual at a request of a service provider that the personal information be stored, (b) determining, based on the confirmation from the individual, whether the storage of the personal information in the storage part is authorized, and (c) storing the personal information of the individual in the storage part if the step (b) determines that the storage of the personal information is authorized.

### BRIEF DESCRIPTION OF THE DRAWINGS

Other objects, features and advantages of the present invention will become more apparent from the following detailed description when read in conjunction with the accompanying drawings, in which:

FIG. 1 is a diagram showing a system configuration according to an embodiment of the present invention;

FIG. 2 is a flowchart for illustrating a general operation flow of personal information management according to the embodiment of the present invention;

FIG. 3 is a flowchart for illustrating a flow of a storage operation according to the embodiment of the present invention;

FIG. 4 is a flowchart for illustrating a flow of a reference operation according to the embodiment of the present invention;

FIG. 5 is a diagram showing a state of a personal information database according to the embodiment of the present invention;

FIG. 6 is a diagram showing another state of the personal information database according to the embodiment of the present invention;

FIG. 7 is a diagram showing another state of the personal information database according to the embodiment of the present invention;

FIG. 8A is a diagram showing a screen image of a member terminal, FIG. 8B is a diagram showing another screen image of the member terminal, FIG. 8C is a diagram showing a screen image of a hospital terminal, and FIG. 8D is a diagram showing another screen image of the member terminal according to the embodiment of the present invention;

FIG. 9 is a diagram showing another screen image of the member terminal according to the embodiment of the present invention;

FIGS. 10A and 10B are diagrams showing screen images of an insurance company terminal according to the embodiment of the present invention;

FIG. 11A is a diagram showing another screen image of the member terminal and FIG. 11B is a diagram showing another screen image of the member terminal or the hospital terminal according to the embodiment of the present invention;

FIGS. 12A and 12B are diagrams showing states of a hospital terminal database according to the embodiment of the present invention;

FIG. 13 is a diagram showing a state of an insurance company terminal database according to the embodiment of the present invention;

FIG. 14 is another flowchart for illustrating the general operation flow of the personal information management according to the embodiment of the present invention;

FIGS. 15A through 15C are diagrams showing states of a shop terminal database according to the embodiment of the present invention;

FIGS. 16A and 16B are diagrams showing states of the personal information database according to the embodiment of the present invention;

FIG. 17 is a diagram showing a state of a hospital database according to the embodiment of the present invention;

FIG. 18 is a diagram showing a state of an insurance company database according to the embodiment of the present invention;

FIGS. 19A and 19B are diagrams showing states of a shop database according to the embodiment of the present invention; and

FIGS. 20A and 20B are diagrams showing screen images of a shop terminal according to the embodiment of the present invention.

### DETAILED DESCRIPTION OF THE PREFERRED EMBODIMENTS

A description will now be given, with reference to the accompanying drawings, of an embodiment of the present invention.

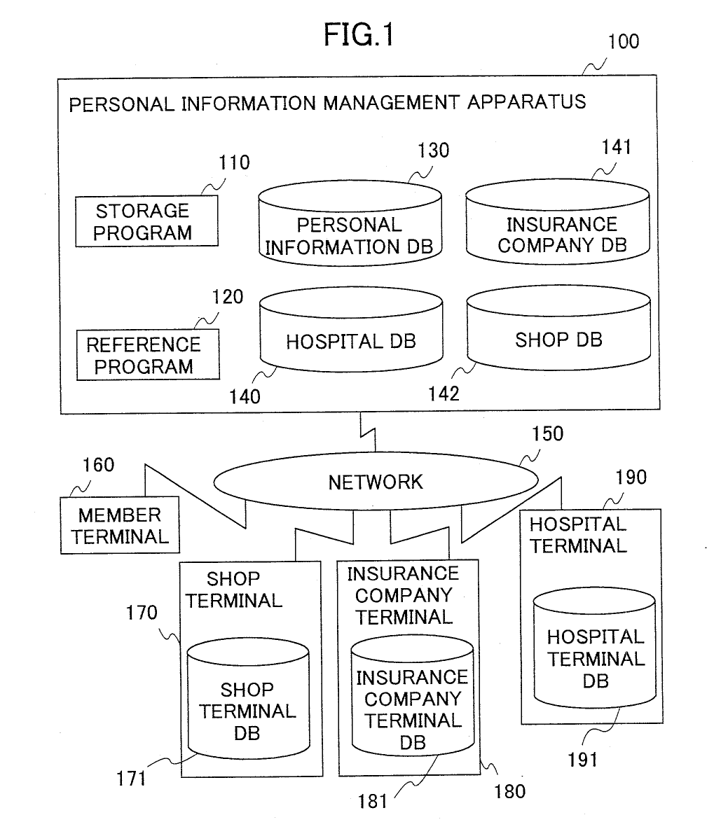

FIG. 1 is a diagram showing a system configuration of this embodiment. In the system of FIG. 1, a personal information management apparatus 100 is a computer including a processor and a memory. At least one member terminal 160 operated by a member, at least one shop terminal 170 operated by a shop clerk, at least one insurance company terminal 180 operated by a company employee, and at least one hospital terminal 190 operated by a hospital staff member are connected to the personal information management apparatus 100 via a network 150.

The personal information management apparatus 100 is provided, for instance, in a personal information management center managing personal information such as bank account numbers, medical certificates, and shopping points. The personal information management center is accessible from any of the member terminal 160, the shop terminal 170, the insurance company terminal 180, and the hospital terminal 190. The personal information management apparatus 100 includes four databases (DBs): a personal information DB 130, a hospital DB 140, an insurance company DB 141, and a shop DB 142; and two programs: a storage program 110 and a reference program 120. The storage program 110, upon receiving a storage request from any of the member, the shop clerk, the insurance company employee, and the hospital staff member, stores the personal information in the personal information DB 130, referring to any of the four DBs 130, 140, 141, and 142. The reference program 120, upon receiving a reference request from any of the member, the shop clerk, the insurance company employee, and the hospital staff member, refers to the personal information stored in the personal information DB 130, referring to any of the four DBs 130, 140, 141, and 142.

The personal information DB 130 is composed mainly of three elements of (a) a common part storing common information on the member, (b) a personal information part only storing information from the member, and (c) an others information part only storing information from those other than the member. In the drawings, (a), (b), and (c) in the personal information DB 130 indicate the common part, the personal information part, and the others information part, respectively. Only a user who holds a later-described reference key is allowed to refer to the personal information DB 130. The components of the common part are member ID, mail address, password, user type, personal area address (address of personal information part), and others area address (address of others information part). The components of each of the personal information part and the others information part are latest data-update date, number of stored data, number of storable data, date of data write, ID of data storer (data writer), data retention period, data area, reference key, date of data reference, and ID of data referrer.

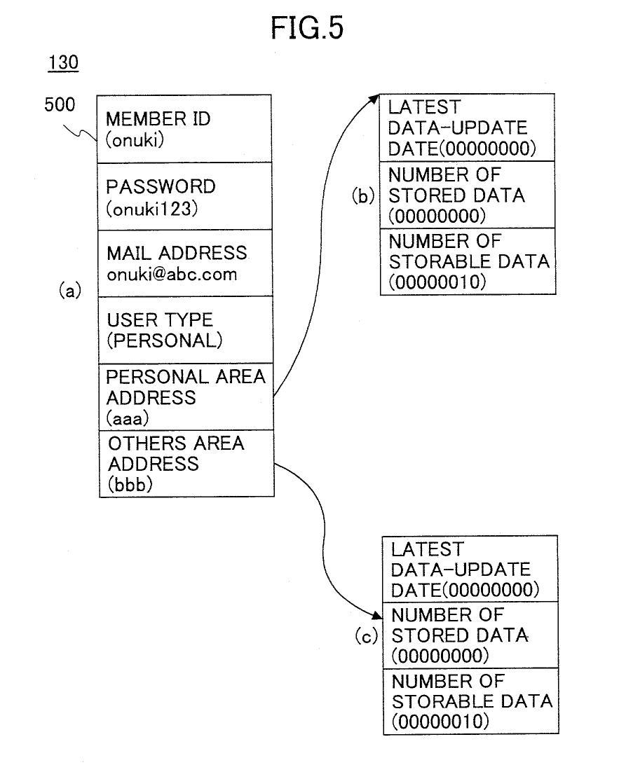

FIG. 5 is a diagram showing an initial state 500 of the personal information DB 130 of member “Onuki”. The following data are set in the DB 130:

member ID: onuki

password: onuki123

mail address: HYPERLINK

mailto:onuki@abc.com onuki@abc.com

user type: personal

personal area address: aaa

others area address: bbb “00000010” is set in the cells of number of storable data, and “00000000” is set in the remaining data items.

The components of the hospital DB 140 are hospital name, login name, password, user type, storage key, and mail address.

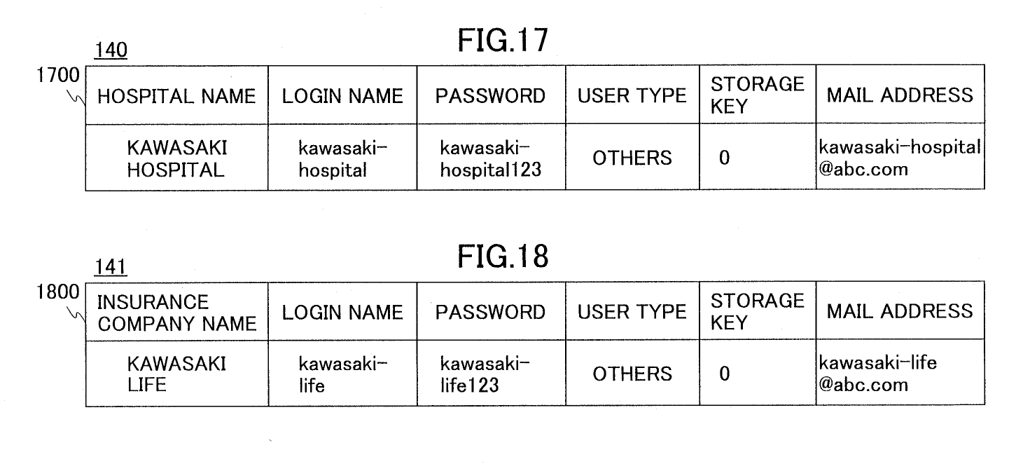

FIG. 17 is a diagram showing an initial state 1700 of the hospital DB 140 of a hospital “Kawasaki Hospital”. The following data are set in the DB 140:

hospital name: Kawasaki Hospital

login name: kawasaki-hospital

password: kawasaki-hospital123

user type: others

storage key: 0

mail address: HYPERLINK mailto:kawasaki-hospital@abc.com kawasaki-hospital@abc.com

The components of the insurance company DB 141 are insurance company name, login name, password, user type, storage key, and mail address.

FIG. 18 is a diagram showing an initial state 1800 of the insurance company DB 141 of an insurance company “Kawasaki Life”. The following data are set in the DB 141:

insurance company name: Kawasaki Life

login name: kawasaki-life

password: kawasaki-life123

user type: others

storage key: 0

mail address: HYPERLINK mailto:kawasaki-life@abc.com kawasaki-life@abc.com

The components of the shop DB 142 are shop name, login name, password, user type, storage key, and mail address.

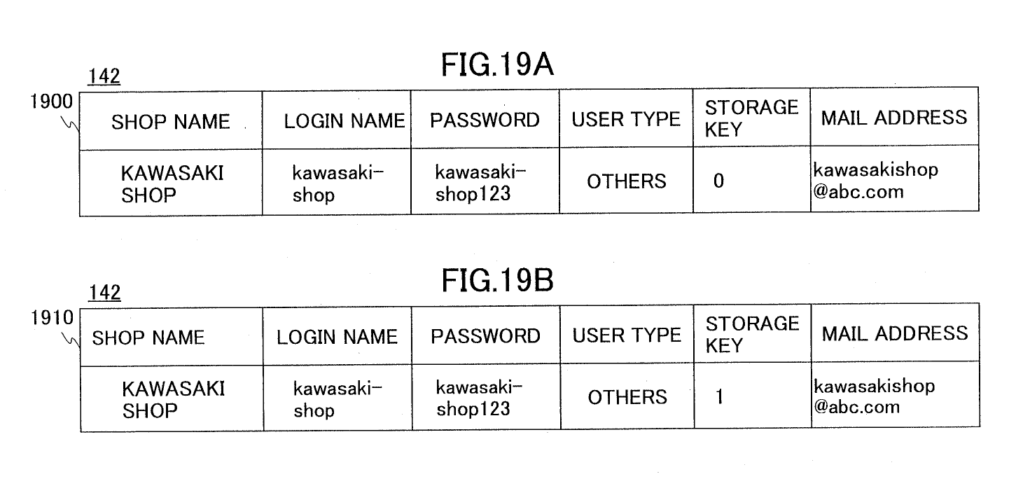

FIG. 19 is a diagram showing an initial state 1900 of the shop DB 142 of a shop “Kawasaki shop”. The following data are set in the DB 142:

shop name: Kawasaki shop

login name: kawasaki-shop

password: kawasaki-shop123

user type: others

storage key: 0

mail address: HYPERLINK mailto:kawasaki-shop@abc.com kawasaki-shop@abc.com

The shop terminal 170 includes a shop terminal DB 171, whose components are ID of personal information management apparatus to be accessed (hereinafter, accessed apparatus ID), login name for accessing personal information management apparatus (hereinafter, access login name), stored data, and reference key.

The insurance company terminal 180 includes an insurance company terminal DB 181, whose components are accessed apparatus ID, access login name, stored data, and reference key.

The hospital terminal 190 includes a hospital terminal DB 191, whose components are accessed apparatus ID, access login name, stored data, and reference key.

A description will be given herein, with reference to FIGS. 1 through 13, 17, and 18, of an operation of the system of FIG. 1. In this operation, the account number of the member, which is the member's own information, is stored at the storage request of the member, that is, at the request of the member to store the account number, the medical certificate of the member is stored at the request of the hospital with the member requesting the hospital to have the medical certificate stored, and insurance payment is made to the member by referring to the account number and the medical certificate at the reference request of the insurance company, that is, at the request of the insurance company to refer to the account number and the medical certificate.

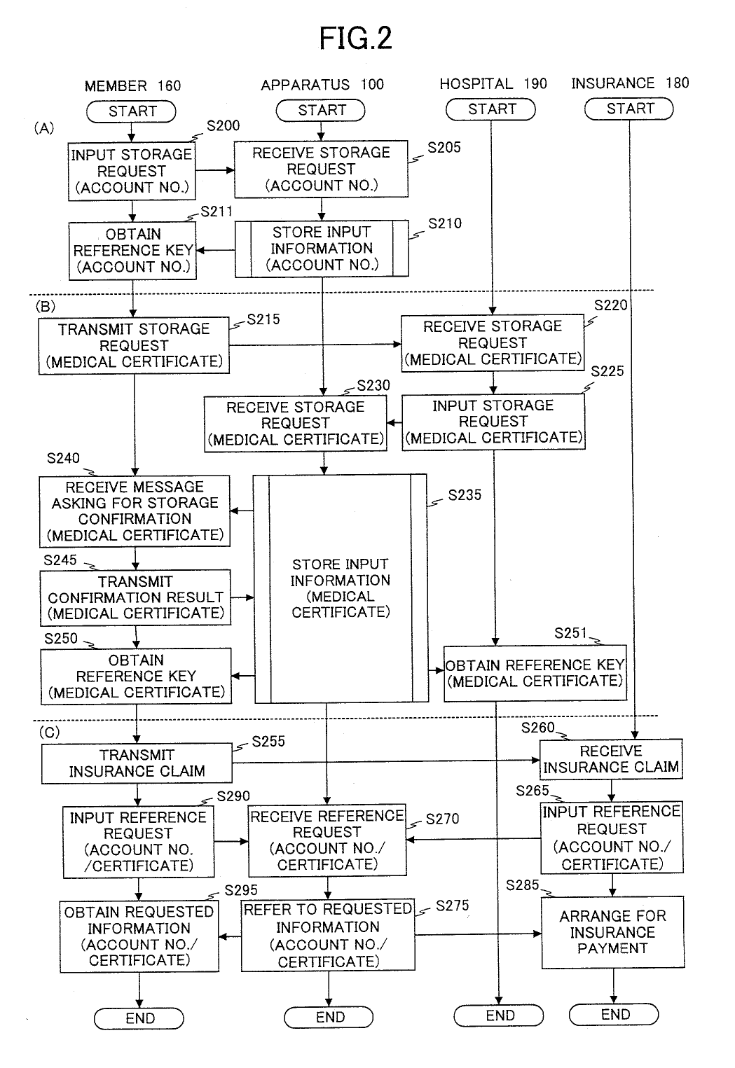

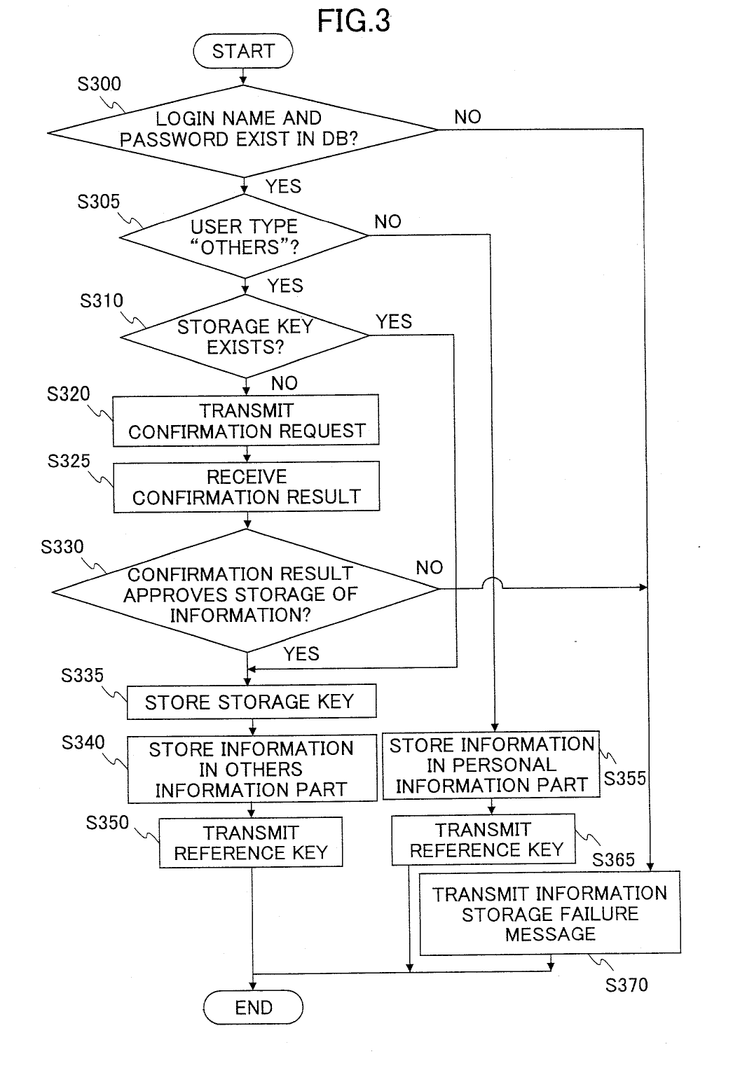

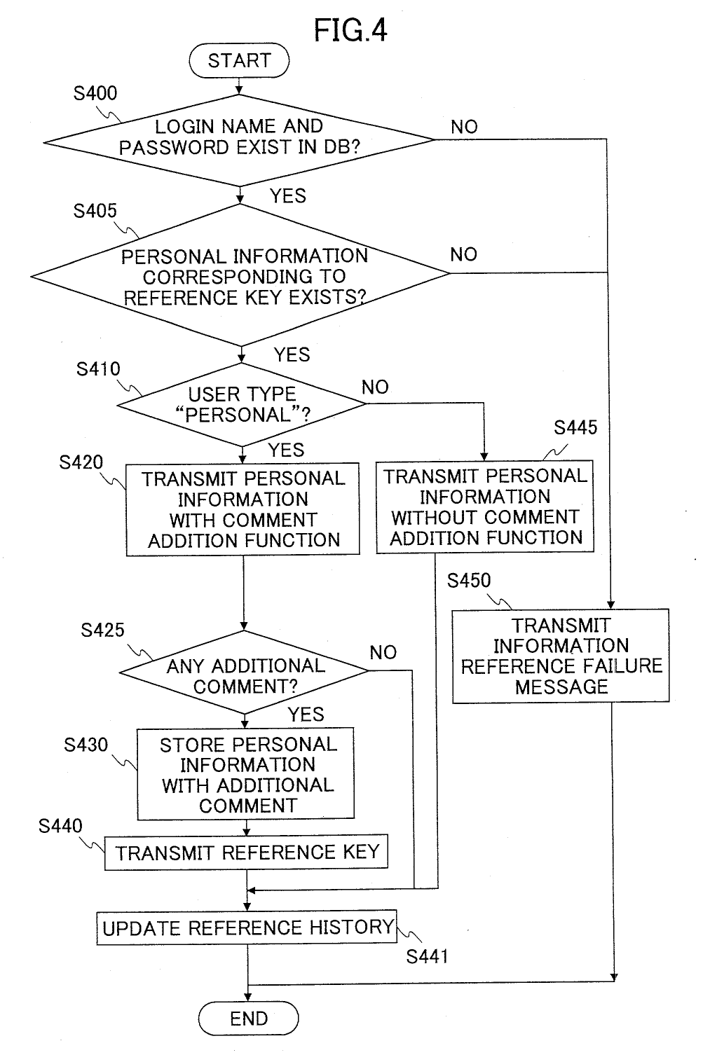

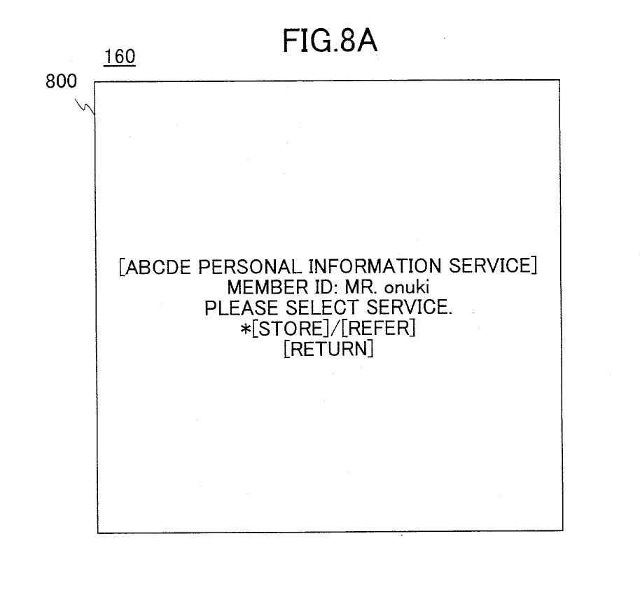

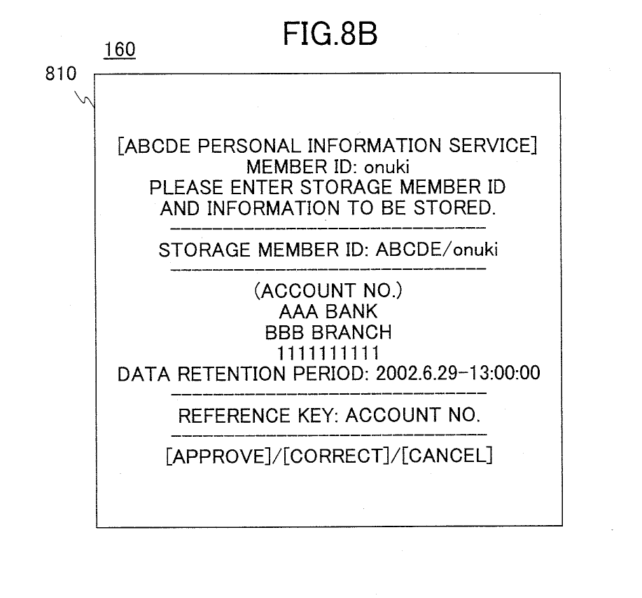

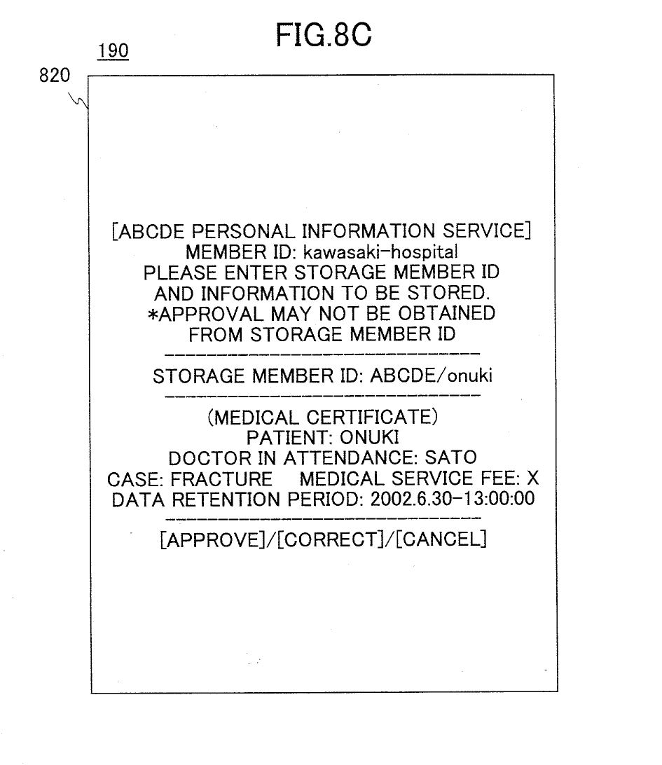

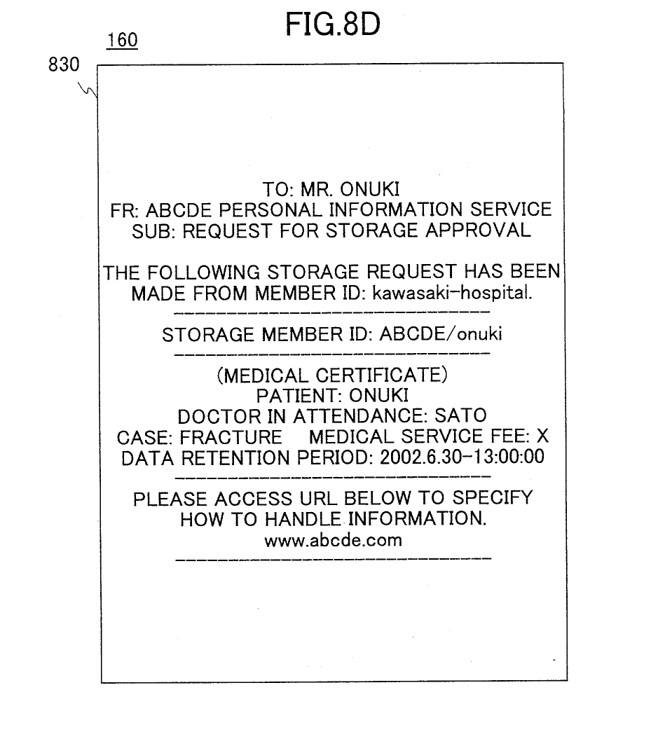

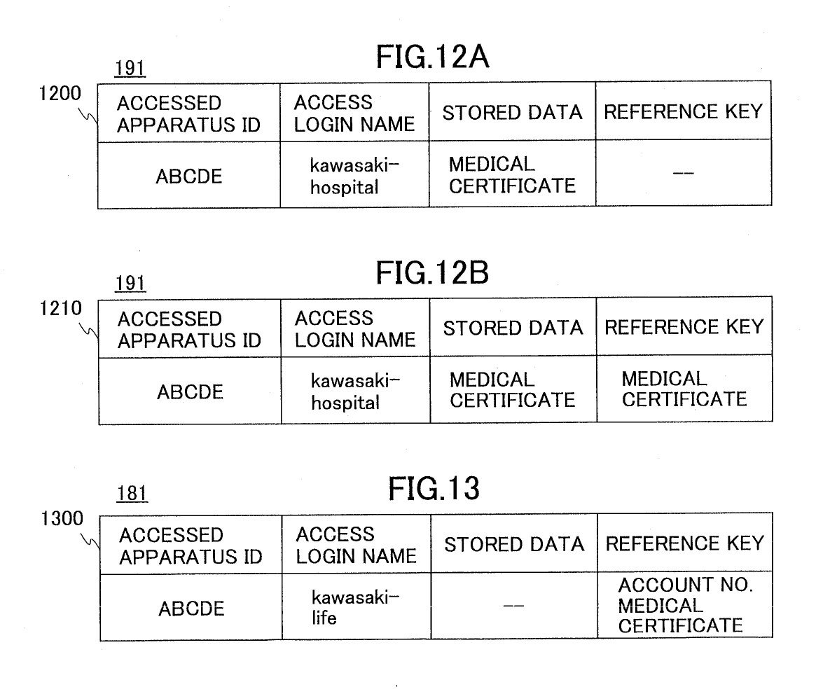

FIG. 2 is a flowchart for illustrating a general operation flow composed of an operation of storing the member information at a request therefor (a storage operation) and an operation of referring to the member information at a request therefor (a reference operation). FIG. 3 is a flowchart of the storage operation. FIG. 4 is a flowchart of the reference operation. FIGS. 5 through 7 are diagrams showing the specific contents of the personal information DB 130. FIGS. 8A through 11B are diagrams showing the specific contents of the screens of the member terminal 160, the insurance company terminal 180, and the hospital terminal 190. FIGS. 12A and 12B are diagrams showing the hospital terminal DB 191 included in the hospital terminal 190. FIG. 13 is a diagram showing the insurance company terminal DB 181 included in the insurance company terminal 180. FIG. 17 is a diagram showing the hospital DB 140 included in the personal information management apparatus 100. FIG. 18 is a diagram showing the insurance company DB 141 included in the personal information management apparatus 100.

A description will be given, with reference to FIG. 2, of the operation of the system at the time of performing the storage and reference operations. In FIG. 2, (A) indicates a sequence of steps for storing the account number at the storage request of the member, (B) indicates a sequence of steps for storing the medical certificate at the storage request of the hospital, and (C) indicates a sequence of steps for referring to the account number and the medical certificate at the reference request of the insurance company.

First, in step S200, the member terminal 160 inputs a request for the personal information management apparatus 100 to store the account number.

FIG. 8A is a diagram showing a screen image 800 of the member terminal 160 at the time of the member (“Onuki”) logging in to the personal information management apparatus 100 and selecting a “storage” service.

FIG. 8B is a diagram showing a screen image 810 of the member terminal 160 at the time of the member (“Onuki”) inputting data of bank name “AAA Bank”, branch name “BBB branch”, account number “1111111111”, data retention period “2002.6.29-13:00:00”, and reference key “account number” to the personal information management apparatus 100.

In step S205, the personal information management apparatus 100 receives the storage request and, in step S210, stores the input account number in the personal information DB 130.

In step S211, the member terminal 160 obtains a search key stored together with the account number in step S210 and stores the search key in a primary storage.

Next, in step S215, the member terminal 160 inputs a request for the hospital terminal 190 to have the medical certificate stored.

In step S220, the hospital terminal 190 receives the storage request and, in step S225, inputs a request for the personal information management apparatus 100 to store the medical certificate.

FIG. 12A is a diagram showing an initial state 1200 of the hospital terminal DB 191 of the hospital “Kawasaki Hospital”. The following data are set in the DB 191:

accessed apparatus ID: ABCDE

access login name: kawasaki-hospital

stored data: medical certificate

reference key:

In step S230, the personal information management apparatus 100 receives the storage request and, in step S235, stores the input medical certificate in the personal information DB 130.

FIG. 8C is a diagram showing a screen image 820 of the hospital terminal 190 at the time of the hospital (“kawasaki-hospital”) inputting data of patient “Onuki”, doctor in attendance “Sato”, case “fracture”, medical service fee “X”, and data retention period “2002.6.30-13:00:00” to the personal information management apparatus 100.

However, in the case of storing the others information such as a medical certificate in the personal information DB 130, the personal information management apparatus 100 confirms with the member terminal 160 whether the personal information management apparatus 100 may store the information requested to be stored in the personal information DB 130. In step S240, the member terminal 160 receives a message from the personal information management apparatus 100 asking for confirmation as to whether to store the requested information (medical certificate) in the personal information DB 130, and displays the confirmation request message asking for storage confirmation.

FIG. 8D is a diagram showing a screen image 830 of the member terminal 160 at the time of the member (“Onuki”) receiving the message from the personal information management apparatus 100 asking for confirmation as to whether to store the medical certificate from the hospital (“kawasaki-hospital”) including the data of patient “Onuki”, doctor in attendance “Sato”, case “fracture”, medical service fee “X”, and data retention period “2002.6.30-13:00:00”.

In step S245, the member (“Onuki”) confirms whether to store the medical certificate based on the received message, and if the member confirms that the medical certificate is to be stored, the member determines a reference key for the medical certificate and transmits a result of confirmation including the reference key to the personal information management apparatus 100..

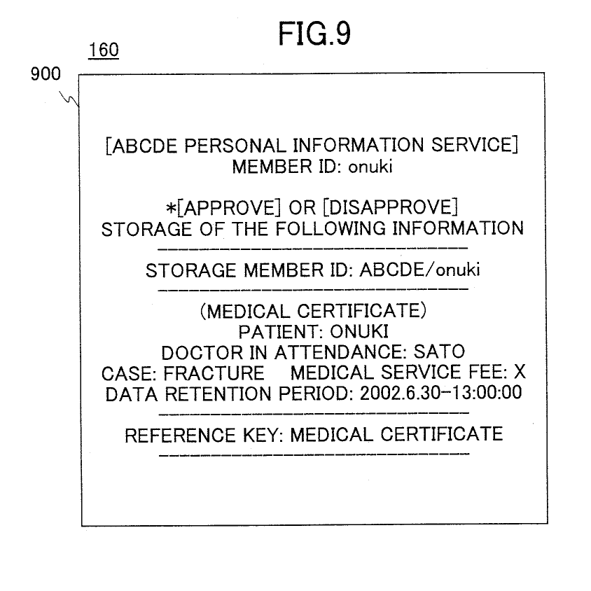

FIG. 9 is a diagram showing a screen image 900 of the member terminal 160 at the time of the member (“Onuki”) transmitting the confirmation result after confirming that the medical certificate is to be stored based on the received message asking for storage confirmation and inputting the reference key “medical certificate”.

In step S235, the personal information management apparatus 100 stores the medical certificate in the personal information DB 130 and a storage key in the hospital DB 140.

In step S250, the member terminal 160 obtains a search key stored together with the medical certificate in step S235 and stores the search key in the primary storage.

In step S251, the hospital terminal 190 obtains the search key stored together with the medical certificate in step S235 and stores the search key in the hospital terminal DB 191.

FIG. 12B is a diagram showing a state 1210 of the hospital terminal DB 191 after step S251. The following data are set in the DB 191:

accessed apparatus ID: ABCDE

access login name: kawasaki-hospital

stored data: medical certificate

reference data: medical certificate

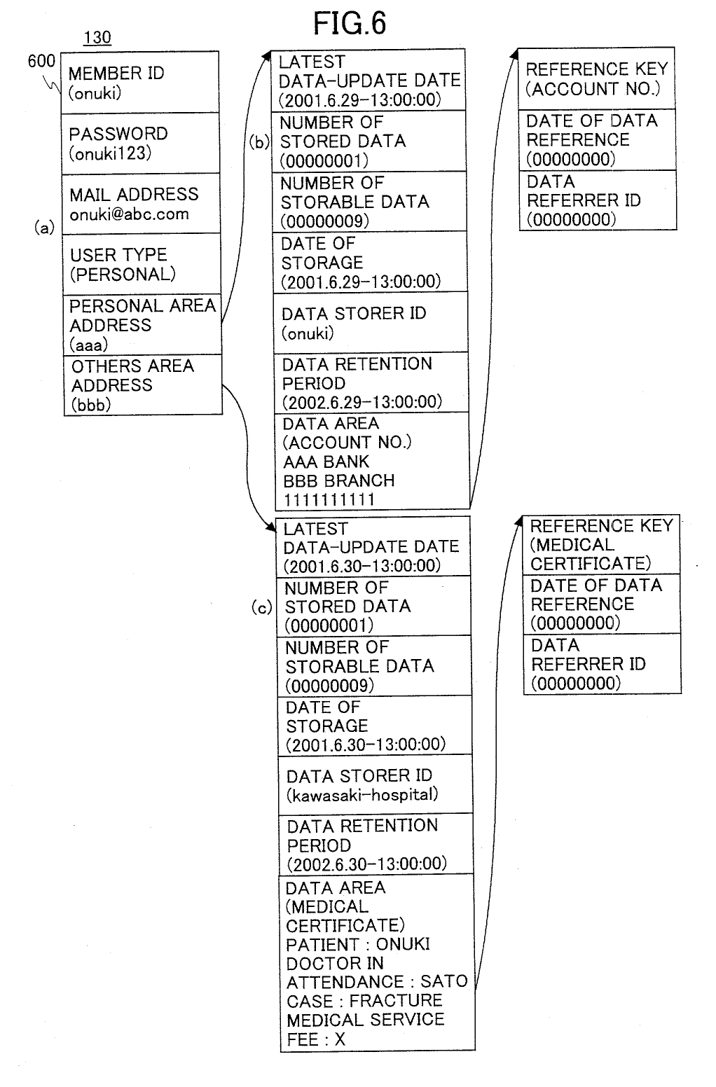

FIG. 6 is a diagram showing a state 600 of the personal information DB 130 of the member (“Onuki”) after step S235. The following data are set in the DB 130 in this state:

in the common part,

member ID: onuki

password: onuki123

mail address: HYPERLINK

mailto:onuki@abc.com onuki@abc.com

user type: personal

personal area address: aaa

others area address: bbb

in the personal information part,

latest data-update date: 2001.6.29-13:00:00

number of stored data: 1

number of storable data: 9

date of storage: 2001.6.29-13:00:00

data storer ID: onuki

data retention period: 2002.6.29-13:00:00

data area: account number

reference key: account number

and in the others information part,

latest data-update date: 2001.6.30-13:00:00

number of stored data: 1

number of storable data: 9

date of storage: 2001.6.30-13:00:00

data storer ID: kawasaki-hospital

data retention period: 2002.6.30-13:00:00

data area: medical certificate

reference key: medical certificate

Thereafter, in step S255, the member terminal 160 transmits an insurance claim based on the account number and the medical certificate to the insurance company terminal 180.

In step S260, the insurance company terminal 180 receives the insurance claim and, in step S265, inputs a request for the personal information management apparatus 100 to refer to the account number and the medical certificate.

FIG. 13 is a diagram showing a state 1300 of the insurance company terminal DB 181 of the insurance company “Kawasaki Life” after step S265. The following data are set in the DB 181:

accessed apparatus ID: ABCDE

access login name: kawasaki-life

stored data: -

reference data: account number, medical certificate

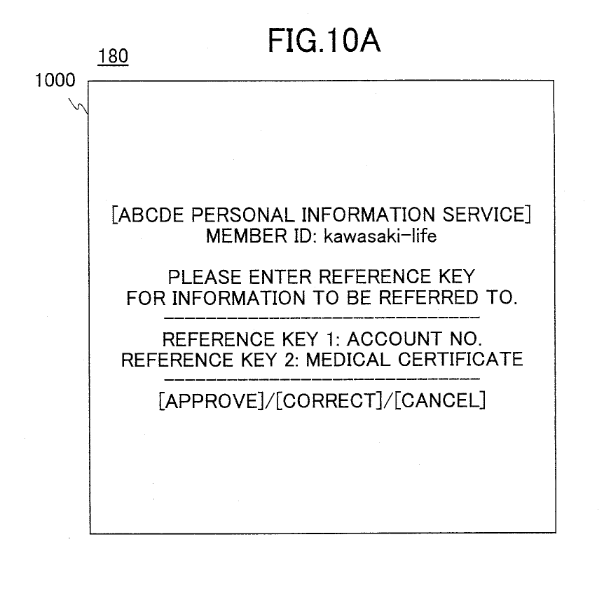

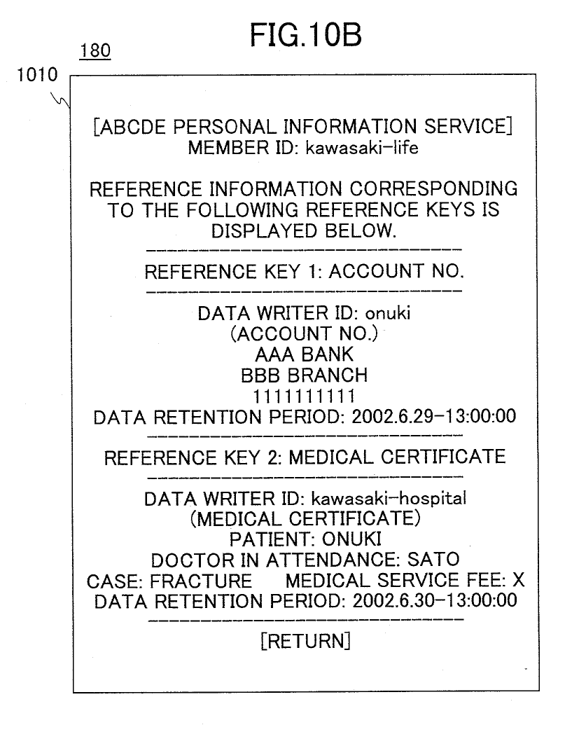

FIG. 10A is a diagram showing a screen image 1000 of the insurance company terminal 180 at the time of the insurance company (“kawasaki-life”) inputs two reference keys of the account number and the medical certificate as input information for the reference request.

In step S270, the personal information management apparatus 100 receives the reference request. In step S275, the personal information management apparatus 100 searches the personal information DB 130 based on the reference keys of the account number and the medical certificate, and refers to the account number and the medical certificate.

In step S285, the insurance company terminal 180 arranges for insurance payment based on the account number and the medical certificate obtained in step S275.

FIG. 10B is a diagram showing a screen image 1010 of the insurance company terminal 180 at the time of the insurance company (“kawasaki-life”) searching the personal information DB 130 included in the personal information management apparatus 100 based on the reference keys of “account number” and “medical certificate” and obtaining as reference information the account number composed of bank name “AAA Bank”, branch name “BBB branch”, account number “1111111111”, and data retention period “2002.6.29-13:00:00” and the medical certificate composed of patient “Onuki”, doctor in attendance “Sato”, case “fracture”, medical service fee “X”, and data retention period “2002.6.30-13:00:00”.

Steps S290 and S295 are part of a sequence of steps taken in the case of referring to the account number and the medical certificate at the request of the member and correspond to steps S265 and S285.

In step S290, the member terminal 160 inputs a request for the personal information management apparatus 100 to refer to the account number and the medical certificate.

In step S295, the member terminal 160 obtains the account number and the medical certificate obtained in step S275.

A description will now be given, with reference to FIG. 3, of the storage operation of the personal information management apparatus 100.

In step S300, the personal information management apparatus 100 determines whether a login name and a password included in a storage request transmitted from a terminal requesting storage of information, for instance, the member terminal 160, exist in the personal information DB 130.

If the login name and the password exist in the personal information DB 130 (that is, “YES” in step S300), in step S305, the personal information management apparatus 100 determines whether the user type is “others”.

If the login name and the password do not exist in the personal information DB 130 (that is, “NO” in step S300), in step S370, the personal information management apparatus 100 transmits a message that the requesting terminal has failed in storing the information (an information storage failure message) to the requesting terminal (the member terminal 160).

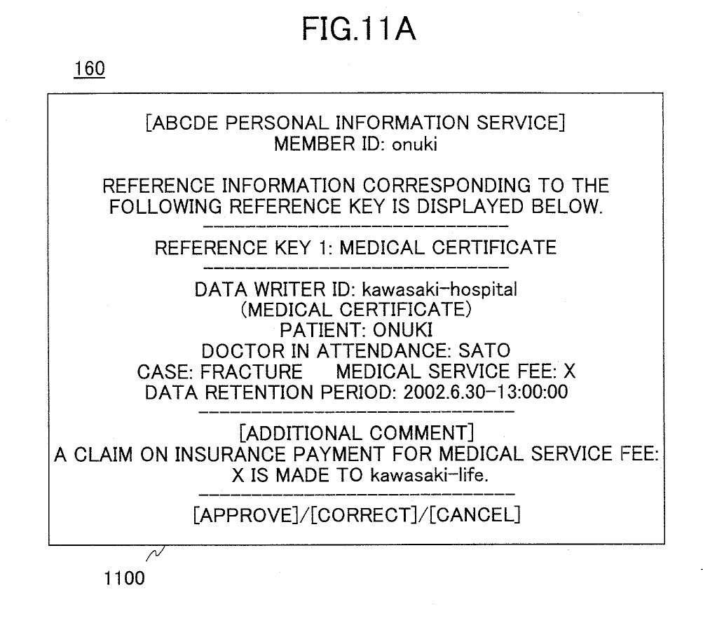

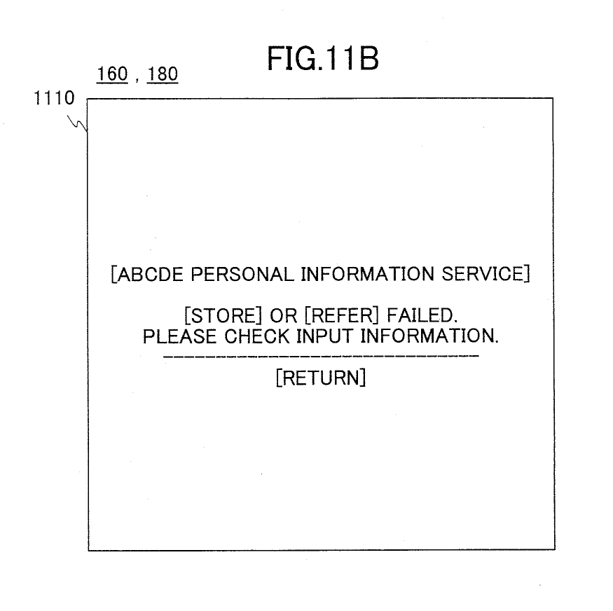

FIG. 11B is a diagram showing a screen image 1110 of the member terminal 160 at the time of the member receiving the information storage failure message from the personal information management apparatus 100.

If the personal information management apparatus 100 determines in step S305 that the user type is not “others”, in step S355, the personal information management apparatus 100 stores the information to be stored and a reference key corresponding thereto both included in the storage request in the personal information part of the personal information DB 130. Then, in step S365, the personal information management apparatus 100 transmits the reference key to the member terminal 160 that has requested storage of the information.

The common part and the personal information part of the personal information DB 130 storing the information to be stored and the reference key “account number” input to the screen image 810 by the member “onuki” whose user type is “personal” are as indicated by (a) and (b) in FIG. 6.

If the user type is “others” (that is, “YES” in step S305), in step S310, the personal information management apparatus 100 determines whether a storage key exists in one of the DBs 140 through 142 in the personal information management apparatus 100 which one corresponds to the requesting terminal. If no storage key exists (that is, “NO” in step S310), in step S320, the personal information management apparatus 100 transmits a confirmation request (message) to the member terminal 160.

In step S325, the personal information management apparatus 100 receives a confirmation result transmitted from the member terminal that has received the confirmation request.

In step S330, the personal information management apparatus 100 determines whether the confirmation result approves storage of the information.

If the confirmation results approves storage of the information (that is, “YES” in step S330), in step S335, the personal information management apparatus 100 stores a storage key in the corresponding one of the DBs 140 through 142 and, in step S340, stores the information and a reference key corresponding thereto both included in the storage request in the others information part of the personal information DB 130. In step S350, the personal information management apparatus 100 transmits the reference key input by the member to the requesting terminal.

If the confirmation result does not approve storage of the information (that is, “NO” in step S330), in step S370, the personal information management apparatus 100 transmits the information storage failure message to the requesting terminal.

If a storage key exists (that is, “YES” in step S310), steps S335 and S340 are performed and, in step S350, the personal information management apparatus 100 transmits the reference key to the requesting terminal, for instance, the hospital terminal 190.

Next, a description will be given, with reference to FIG. 4, of the reference operation of the personal information management apparatus 100.

In step S400, the personal information management apparatus 100 determines whether a login name and a password included in a reference request transmitted from a terminal, for instance, the insurance company terminal 180, exist in the insurance company DB 141.

If the login name and the password exist (that is, “YES” in step S400), in step S405, the personal information management apparatus 100 determines whether personal information corresponding to a reference key input from the requesting terminal (the insurance company terminal 180) exists in the personal information DB 130.

If the login name and the password do not exist in the insurance company DB 141 (that is, “NO” in step S400), in step S450, the personal information management apparatus 100 transmits an information reference failure message to the insurance company terminal 180.

The insurance company terminal 180 also has the screen image 1110 shown in FIG. 11B when the insurance company terminal 180 receives the information reference failure message from the personal information management apparatus 100.

If personal information corresponding to the input reference key exists in the personal information DB 130 (that is, “YES” in step S405), in step S410, the personal information management apparatus 100 determines whether the user type is “personal”.

If the user type is not “personal” (that is, “NO” in step S410), in step S445, the personal information management apparatus 100 transmits the personal information corresponding to the reference key without the function of permitting a comment to be added to the personal information. Then, in step S441, the personal information management apparatus 100 updates a reference history.

If the user type is “personal” (that is, “YES” in step S410), in step S420, the personal information management apparatus 100 transmits the personal information corresponding to the reference key with the function of permitting a comment to be added to the personal information.

In step S425, the personal information management apparatus 100 determines whether any additional comment to the personal information is returned.

FIG. 11A is a diagram showing a screen image 1100 of the member terminal 160 in the case of the member (“onuki”) searching the personal information DB 130 in the personal information management apparatus 100 based on the two reference keys “account number” and “medical certificate”, obtaining as reference information the account number composed of data of bank name “AAA Bank”, branch name “BBB branch”, account number “1111111111”, and data retention period “2002.6.29-13:00:00” and the medical certificate composed of data of patient “Onuki”, doctor in attendance “Sato”, case “fracture”, medical service fee “X”, and data retention period “2002.6.30-13:00:00”, and further inputting an additional comment “A claim on insurance payment for the medical service fee “X” is made to kawasaki-life.”

If the personal information management apparatus 100 receives an additional comment (that is, “YES” in step S425), in step S430, the personal information management apparatus 100 stores the personal information with the additional comment in the personal information part of the personal information DB 130. Then, the personal information management apparatus 100 transmits the reference key to the requesting terminal and, in step S441, updates the reference history.

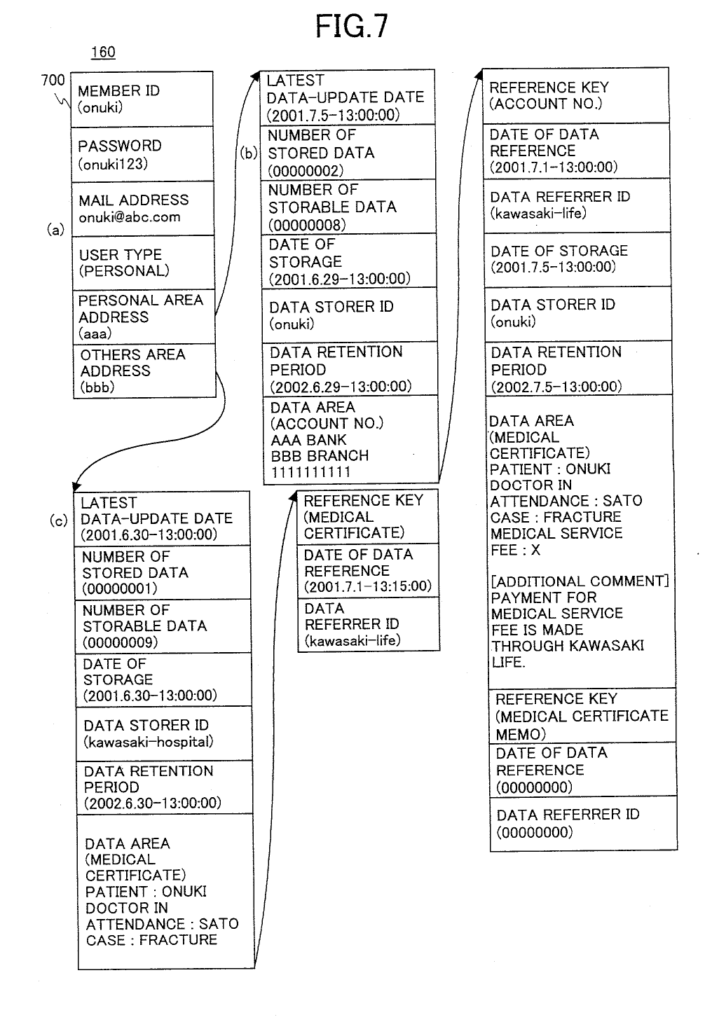

FIG. 7 is a diagram showing a state 700 of the personal information DB 130 of the member (“Onuki”) after step S430. The following data are set in the DB 130 in this state:

in the common part,

member ID: onuki

password: onuki123

mail address: HYPERLINK

mail to: onuki@abc.com onuki@abc.com

user type: personal

personal area address: aaa

others area address: bbb

in the personal information part,

latest data-update date: 2001.7.5-13:00:00

number of stored data: 2

number of storable data: 8

date of storage: 2001.6.29-13:00:00

data storer ID: onuki

data retention period: 2002.6.29-13:00:00

data area: account number

reference key: account number

date of data reference: 2001.7.1-13:00:00

data referrer ID: kawasaki-life

date of storage: 2001.7.5-13:00:00

data storer ID: onuki

data retention period: 2002.7.5-13:00:00

data area: medical certificate

reference key: medical certificate memo and in the others information part,

latest data-update date: 2001.6.30-13:00:00

number of stored data: 1

number of storable data: 9

date of storage: 2001.6.30-13:00:00

data storer ID: kawasaki-hospital

data retention period: 2002.6.30-13:00:00

data area: medical certificate

reference key: medical certificate

date of data reference: 2001.7.1-13:15:00

data referrer ID: kawasaki-life

If the personal information management apparatus 100 receives no additional comment (that is, “NO” in step S425), in step S441, the personal information management apparatus 100 updates the reference history.

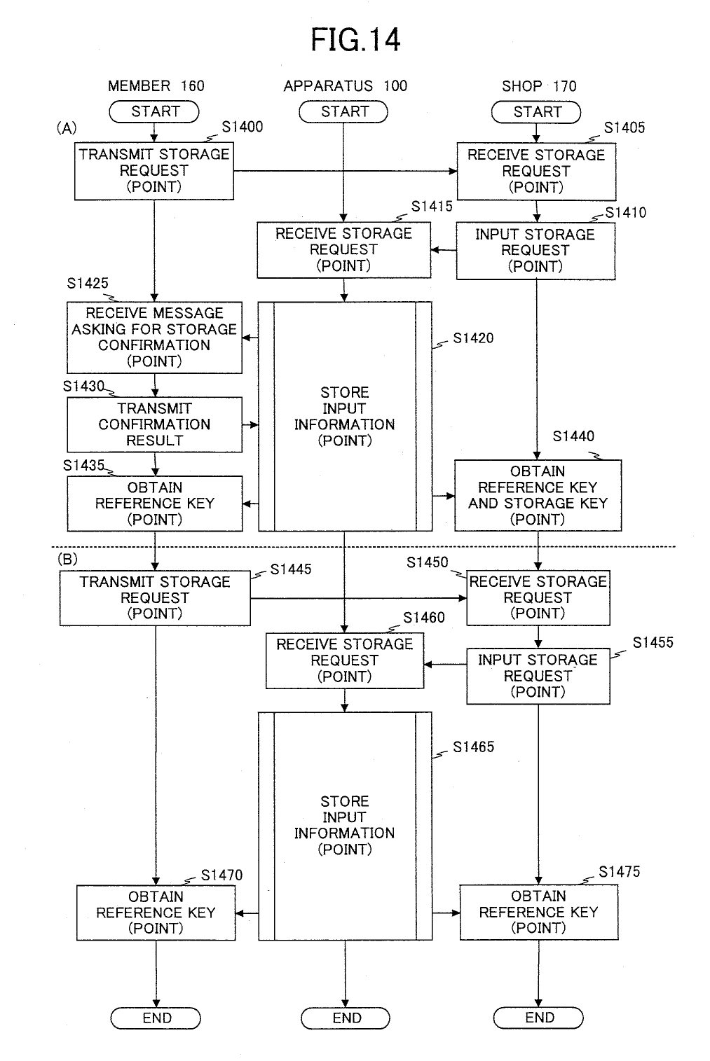

Next, a description will be given, with reference to FIG. 14, of an operation of the personal information management apparatus 100 in the case of accumulating and storing points.

In FIG. 14, (A) indicates a sequence of steps taken in the case of the member requesting the shop to store points for the first time, and (B) indicates a sequence of steps taken in the case of the member requesting the shop to store points after a storage key is issued.

In step S1400 in the sequence (A) of FIG. 14, the member terminal 160 inputs a request for the shop terminal 170 to store points.

In step S1405, the shop terminal 170 receives the storage request and, in step S1410, inputs a request for the personal information management apparatus 100 to store the points.

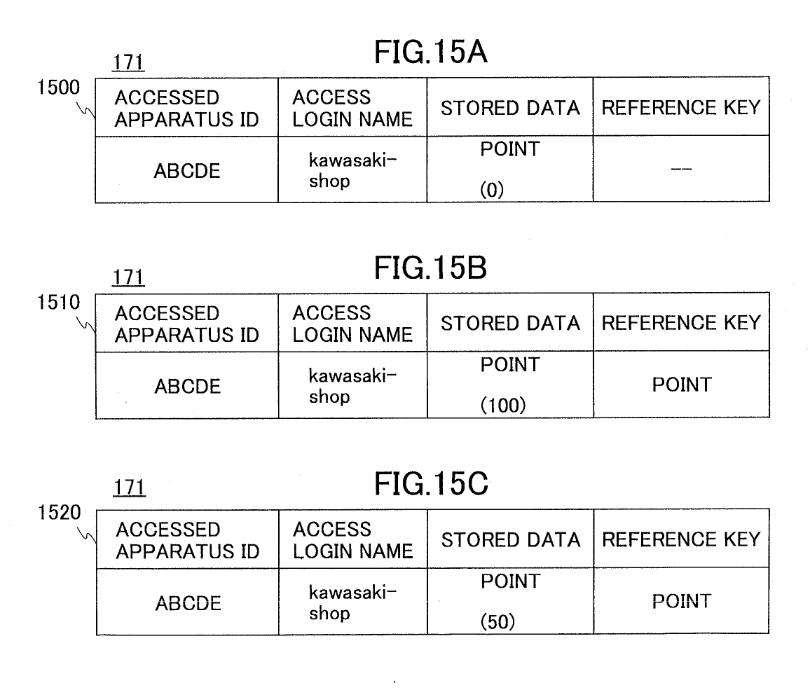

FIG. 15A is a diagram showing an initial state 1500 of the shop terminal DB 171 of the shop “Kawasaki shop”. The following data are set in the DB 171:

accessed apparatus ID: ABCDE

access login name: kawasaki-shop

stored data: point (0)

reference key: -

In step S1415, the personal information management apparatus 100 receives the storage request and, in step S1420, stores the input points in the personal information DB 130 and a storage key in the shop DB 142.

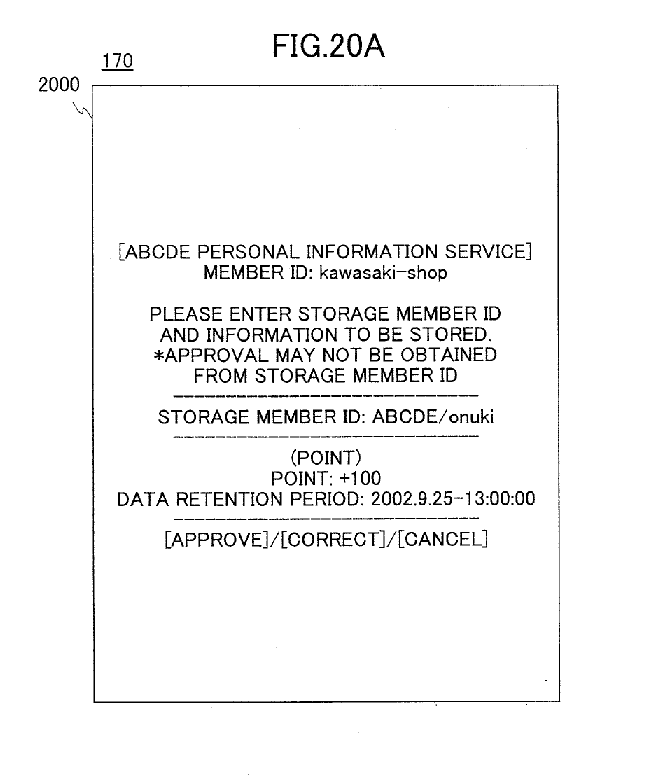

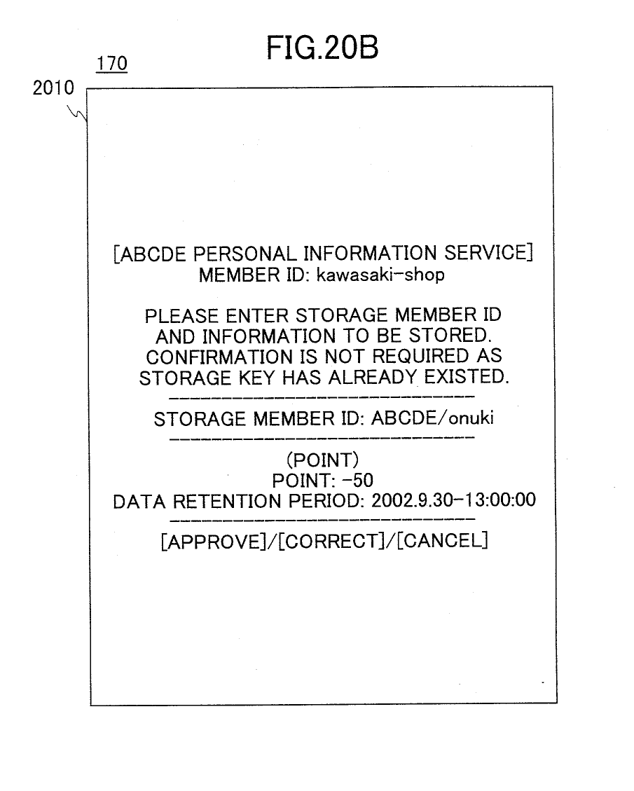

FIG. 20A is a diagram showing a screen image 2000 of the shop terminal 170 at the time of the shop (“kawasaki-shop”) inputting data of member “onuki” and point “+100” to the personal information management apparatus 100.

However, in the case of storing the others information such as points in the personal information DB 130, the personal information management apparatus 100 confirms with the member terminal 160 whether the personal information management apparatus 100 may store the information requested to be stored in the personal information DB 130. In step S1425, the member terminal 160 receives a message from the personal information management apparatus 100 asking for confirmation as to whether to store the requested information (points) in the personal information DB 130, and displays the confirmation request message asking for storage confirmation.

In step S1430, the member (“onuki”) confirms whether to store the points based on the received message, and if the member confirms that the points are to be stored, the member determines a reference key for the points and transmits a result of confirmation including the reference key to the personal information management apparatus 100.

FIG. 19A is a diagram showing a state 1910 of the shop DB 142 of the shop “Kawasaki shop” after step S1440. The following data are set in the DB 142 in this state:

shop name: Kawasaki shop

login name: kawasaki-shop

password: kawasaki-shop123

user type: others

storage key: 1

mail address: HYPERLINK mailto:kawasaki-shop@abc.com kawasaki-shop@abc.com

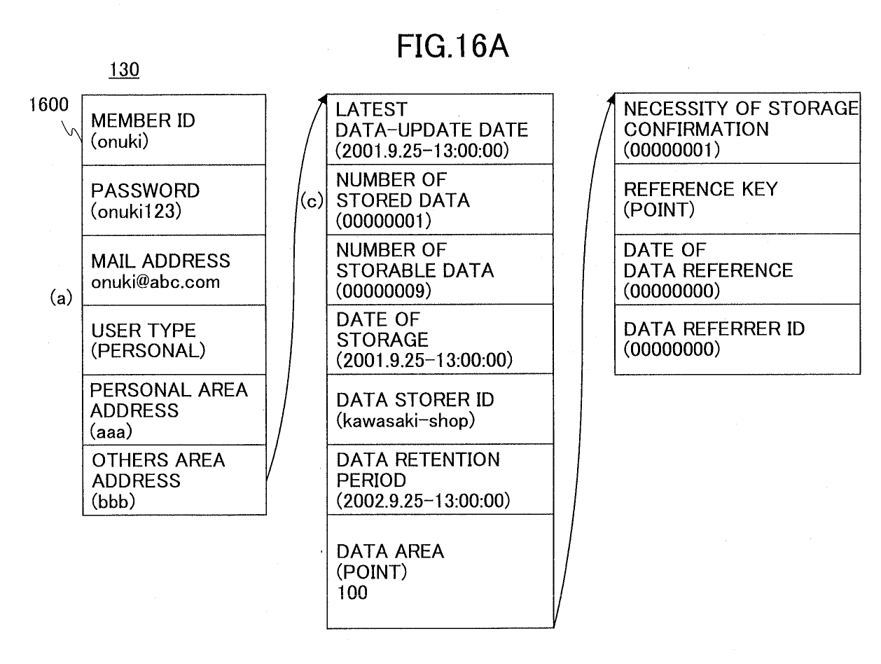

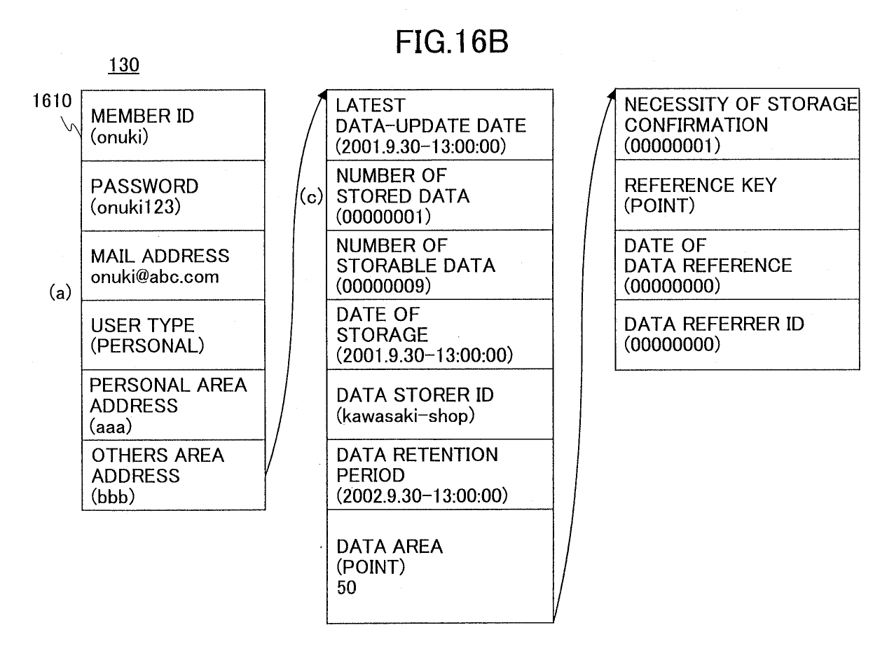

FIG. 16A is a diagram showing a state 1600 of the personal information DB 130 of the member (“Onuki”) after step S1420. The following data is set in the DB 130 in this state:

member ID: onuki

password: onuki123

mail address: HYPERLINK

mailto:onuki@abc.com onuki@abc.com

user type: personal

personal area address: aaa

others area address: bbb

latest data-update date: 2001.9.25-13:00:00

number of stored data: 1

number of storable data: 9

date of storage: 2001.9.25-13:00:00

data storer ID: kawasaki-shop

data retention period: 2002.9.25-13:00:00

data area: point (+100)

reference key: point

In step S1435, the member terminal 160 obtains a search key stored together with the points in step S1420, and stores the search key in the primary storage.

In step S1440, the shop terminal 170 obtains the search key stored together with the points in step S1420, and stores the search key in the shop terminal DB 171 in the shop terminal 170.

FIG. 15B is a diagram showing a state 1510 of the shop terminal DB 171 after step S1440. The following data are set in the DB 171:

accessed apparatus ID: ABCDE

access login name: kawasaki-shop

stored data: point (+100)

reference key: point

In step S1445 in the sequence (B) of FIG. 14, the member terminal 160 inputs a request for the shop terminal 170 having the storage key in the personal information management apparatus 100 to store points.

In step S1450, the shop terminal 170 receives the storage request and, in step S1455, inputs a request for the personal information management apparatus 100 to store the points.

In step S1460, the personal information management apparatus 100 receives the storage request and, in step S1465, stores the input points in the personal information DB 130.

FIG. 20B is a diagram showing a screen image 2010 of the shop terminal 170 at the time of the shop (“kawasaki-shop”) inputting data of member “onuki” and point “−50” to the personal information management apparatus 100.

In step S1465, the personal information management apparatus 100 determines whether the storage key is set in the shop DB 142, and since the storage key is set in the shop DB 142, the personal information management apparatus 100 stores the points in the personal information DB 130 without confirming with the member. Thereafter, the personal information management apparatus 100 transmits the reference key to the member terminal 160 and the shop terminal 170.

FIG. 19B is a diagram showing a state 1910 of the shop DB 142 of the shop “Kawasaki shop” before step S1465. The following data are set in the DB 142 in this state:

shop name: Kawasaki shop

login name: kawasaki-shop

password: kawasaki-shop123

user type: others

storage key: 1

mail address: HYPERLINK mailto:kawasaki-shop@abc.com kawasaki-shop@abc.com

FIG. 16B is a diagram showing a state 1610 of the personal information DB 130 of the member (“Onuki”) after step S1465. The following data are set in the DB 130 in this state:

member ID: onuki

password: onuki123

mail address: HYPERLINK

mailto:onuki@abc.com onuki@abc.com

user type: personal

personal area address: aaa

others area address: bbb

latest data-update date: 2001.9.30-13:00:00

number of stored data: 1

number of storable data: 9

date of storage: 2001.9.30-13:00:00

data storer ID: kawasaki-shop

data retention period: 2002.9.30-13:00:00

data area: point (+50)

reference key: point

In step S1470, the member terminal 160 obtains a search key stored together with the points in step S1465, and stores the search key in the primary storage.

In step S1475, the shop terminal 170 obtains the search key stored together with the points in step S1465, and stores the search key in the shop terminal DB 171.

FIG. 15C is a diagram showing a state 1520 of the shop terminal DB 171 after step S1475. The following data are set in the DB 171:

accessed apparatus ID: ABCDE

access login name: kawasaki-shop

stored data: point (+50)

reference key: point

According to the present invention, a person who claims an insurance payment is freed from filling out a given form to be sent to an insurance company or visiting the hospital for collecting personal information by storing personal information such as an account number and a medical certificate and having the personal information referred to by the insurance company by using the storage and reference system of the present invention.

Further, a person who has left a point card behind can store points for merchandise purchase by using the storage and reference system of the present invention.

The present invention is not limited to the specifically disclosed embodiment, but variations and modifications may be made without departing from the scope of the present invention.

The present application is based on Japanese priority application No. 2001-320012 filed on Oct. 17, 2001, the entire contents of which are hereby incorporated by reference.

What is claimed is:

1. A method of managing personal information, comprising the steps of:
(a) receiving a confirmation from an individual as to whether personal information of the individual is to be stored in a storage part corresponding to the individual at a request of a service provider that the personal information be stored;
(b) determining, based on the confirmation from the individual, whether the storage of the personal information in the storage part is authorized; and
(c) storing the personal information of the individual in the storage part if said step (b) determines that the storage of the personal information is authorized.

2. The method as claimed in claim 1, wherein said step (b) determines whether the storage of the personal information is authorized by using a storage identifier corresponding to the confirmation from the individual.

3. The method as claimed in claim 1, further comprising the step of (d) inquiring of the individual whether the individual authorizes the storage of the personal information in the storage part if said step (b) determines that the storage of the personal information is not authorized.

4. The method as claimed in claim 1, further comprising the steps of:
(d) receiving a reference identifier corresponding to the personal information stored in the storage part from the individual or the service provider; and
(e) extracting the personal information from the storage part based on the reference identifier.

5. The method as claimed in claim 1, wherein the individual transmits the confirmation from a first terminal and the service provider transmits the request from a second terminal, the first and second terminals being connected electrically via a network.

6. An apparatus for managing personal information, comprising:
a storage part storing personal information of an individual corresponding to said storage part, the personal information corresponding to a request of a service provider;
a first part receiving from the individual a confirmation as to whether the personal information is to be stored;
a second part determining, based on the confirmation, whether the storage of the personal information in said storage part is authorized; and
a third part storing the personal information in said storage part if said second part determines that the storage of the personal information is authorized.

7. The apparatus as claimed in claim 6, further comprising a fourth part storing a storage identifier corresponding to the confirmation from the individual,
wherein said second part determines whether the storage of the personal information is authorized by using the storage identifier.

8. The apparatus as claimed in claim 6, further comprising a fourth part inquiring of the individual whether the individual authorizes the storage of the personal information in said storage part if said second part determines that the storage of the personal information is not authorized.

9. The apparatus as claimed in claim 6, wherein further comprising:
a fourth part receiving a reference identifier corresponding to the personal information stored in said storage part from the individual or the service provider; and
a fifth part extracting the personal information from said storage part based on the reference identifier.

10. A computer-readable recording medium storing a program of instructions executable by a computer to perform a method of managing personal information, the method comprising the steps of:
(a) receiving a confirmation from an individual as to whether personal information of the individual is to be stored in a storage part corresponding to the individual at a request of a service provider that the personal information be stored;
(b) determining, based on the confirmation from the individual, whether the storage of the personal information in the storage part is authorized; and
(c) storing the personal information of the individual in the storage part if said step (b) determines that the storage of the personal information is authorized.

11. The recording medium as claimed in claim 10, wherein said step (b) determines whether the storage of the personal information is authorized by using a storage identifier corresponding to the confirmation from the individual.

12. The recording medium as claimed in claim 10, wherein the method further comprises the step of (d) inquiring of the individual whether the individual authorizes the storage of the personal information in the storage part if said step (b) determines that the storage of the personal information is not authorized.

13. The recording medium as claimed in claim 10, wherein the method further comprises the steps of:
(d) receiving a reference identifier corresponding to the personal information stored in the storage part from the individual or the service provider; and
(e) extracting the personal information from the storage part based on the reference identifier.

14. The recording medium as claimed in claim 10, wherein the individual transmits the confirmation from a first terminal and the service provider transmits the request from a second terminal, the first and second terminals being connected electrically via a network.
